(19) United States
(12) Patent Application Publication
(10) Pub. No.: US 2024/0410328 A1
(43) Pub. Date: Dec. 12, 2024

(54) Resiliently Expandable Heated Fuel Filter Cover

(71) Applicant: Charles Mitchell, Holliday, MO (US)

(72) Inventor: Charles Mitchell, Holliday, MO (US)

(21) Appl. No.: 18/787,683

(22) Filed: Jul. 29, 2024

Related U.S. Application Data
(63) Continuation-in-part of application No. 18/206,690, filed on Jun. 7, 2023, now abandoned.

(51) Int. Cl. F02M 31/125

(52) U.S. Cl. CPC F02M 31/125

(57) ABSTRACT

A resiliently expandable heated fuel filter cover system includes an internal combustion engine that has a fuel filter. A sock is provided which can be slid over the fuel filter of the internal combustion engine. The sock is comprised of a thermally insulating material to inhibit thermal communication between the fuel filter and ambient air. A heating element is integrated into the sock and the heating element is in thermal communication with the sock thereby facilitating the heating element to heat the sock when the heating element is turned on. In this way the heating element can heat the fuel filter thereby inhibiting diesel fuel in the fuel filter from gelling in a cold environment.

### CROSS-REFERENCE TO RELATED APPLICATIONS

This application is a continuation in part and I hereby claim the benefit under 35 U.S.C., Section 120 of U.S. application Ser. No. 18/206,690 filed Jun. 7, 2023.

### STATEMENT REGARDING FEDERALLY SPONSORED RESEARCH OR DEVELOPMENT

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### Statement Regarding Prior Disclosures by the Inventor or Joint Inventor

Not Applicable

### BACKGROUND OF THE INVENTION

### (1) Field of the Invention

The disclosure relates to fuel filter devices and more particularly pertains to a new fuel filter device for inhibiting diesel fuel from gelling in a fuel filter. The device includes a sock that is resiliently expandable to be slid over a fuel filter of a diesel engine and conform to a shape of the fuel filter and a heating element integrated into the sock. The heating element may include a power cord that is attachable to a power source of the diesel engine thereby powering the heating element to warm the fuel filter. In this way the heating element inhibits diesel fuel from gelling in the fuel filter in a cold environment.

### (2) Description of Related Art Including Information Disclosed Under 37 CFR 1.97 and 1.98

The prior art relates to fuel filter devices including a variety of fuel filter sleeves that include a heating element and a rigid structural component for warming a fuel filter and a variety of fuel filter blanket devices that each includes a blanket which can be wrapped around a fuel filter and a heating element integrated into the blanket for warming the fuel filter. In no instance does the prior art discloses a fuel filter sock that has no rigid structural elements and is resiliently expandable to fit over and conform to a shape of a fuel filter and a heating element integrated into the sock for warming the fuel filter.

### BRIEF SUMMARY OF THE INVENTION

An embodiment of the disclosure meets the needs presented above by generally comprising an internal combustion engine that has a fuel filter. A sock is provided which can be slid over the fuel filter of the internal combustion engine. The sock is comprised of a thermally insulating material to inhibit thermal communication between the fuel filter and ambient air. A heating element is integrated into the sock and the heating element is in thermal communication with the sock thereby facilitating the heating element to heat the sock when the heating element is turned on. In this way the heating element can heat the fuel filter thereby inhibiting diesel fuel in the fuel filter from gelling in a cold environment.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fuel filter sock device according to an embodiment of the disclosure.

FIG. 2 is a front phantom view of an embodiment of the disclosure.

FIG. 3 is a top view of an embodiment of the disclosure.

FIG. 4 is a bottom view of an embodiment of the disclosure.

FIG. 5 is a cross sectional view taken along line 5-5 of FIG. 2 of an embodiment of the disclosure.

FIG. 6 is a perspective in-use view of an embodiment of the disclosure.

FIG. 7 is a perspective in-use view of an embodiment of the disclosure.

### DETAILED DESCRIPTION OF THE INVENTION

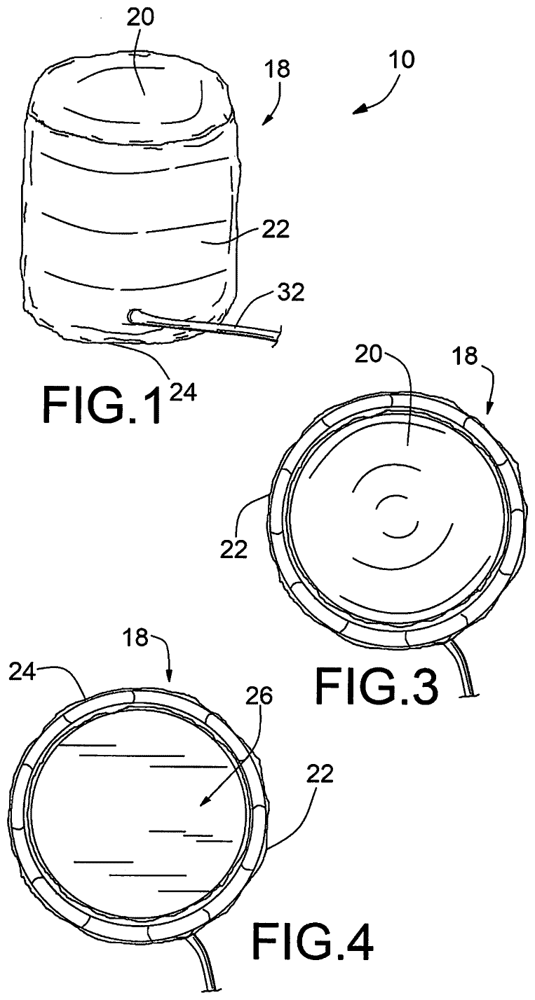

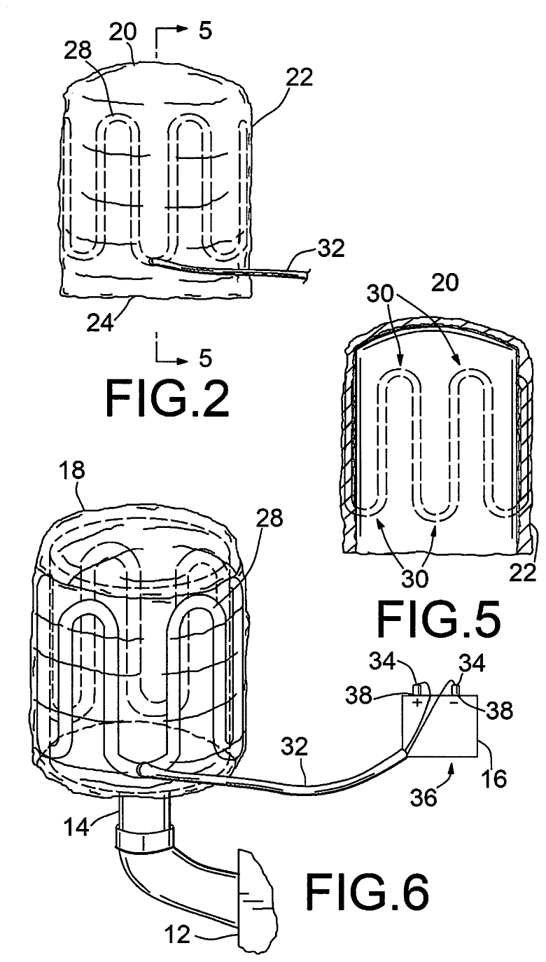

With reference now to the drawings, and in particular to FIGS. 1 through 7 thereof, a new fuel filter device embodying the principles and concepts of an embodiment of the disclosure and generally designated by the reference numeral 10 will be described.

As best illustrated in FIGS. 1 through 7, the fuel filter sock device 10 generally comprises an internal combustion engine 12 of a vehicle that has a fuel filter 14 and a power source 16. The internal combustion engine 12 may be a diesel engine and the fuel filter 14 may be a diesel fuel filter. Furthermore, the vehicle may be a commercial cargo vehicle, construction equipment or other types of heavy vehicles that employ diesel engines. A sock 18 is provided that is cylindrically structured thereby facilitating the sock 18 to be slid over the fuel filter 14 of the internal combustion engine 12. The sock 18 is comprised of a thermally insulating material to inhibit thermal communication between the fuel filter 14 and ambient air. The sock 18 has a top wall 20 and an outer wall 22 extending downwardly from the top wall 20 and the outer wall 22 has a distal edge 24 with respect to the top wall 20 defining an opening 26 into the sock 18. Additionally, the outer wall 22 is continuously arcuate around the top wall 20 such that the sock 18 defines a cylinder when not fit over the fuel filter 14. The sock 18 is free of rigid structural elements and flexible such that the sock 18 conforms to a shape of the fuel filter 14 when the sock 18 is fit over said fuel filter 14.

A heating element 28 is provided and the heating element 28 is integrated into the sock 18. The heating element 28 is flexible such that the heating element 28 facilitates conforming of the sock 18 to the shape of the fuel filter 14 when the sock 18 is fit over the fuel filter 14. The heating element 28 is in thermal communication with the sock 18 meaning the heating element 28 may be either embedded into the outer wall 22 or adhered to an interior face of the outer wall 22 thereby facilitating the heating element 28 to heat the sock 18 when the heating element 28 is turned on and the fuel filter 14 when the sock 18 is fit over the fuel filter 14. In this way the heating element 28 can heat the fuel filter 14 thereby inhibiting diesel fuel in the fuel filter 14 from gelling in a cold environment. In this way the internal combustion engine 12 can be started without difficulty in the cold environment as well as continually operating normally in the cold environment.

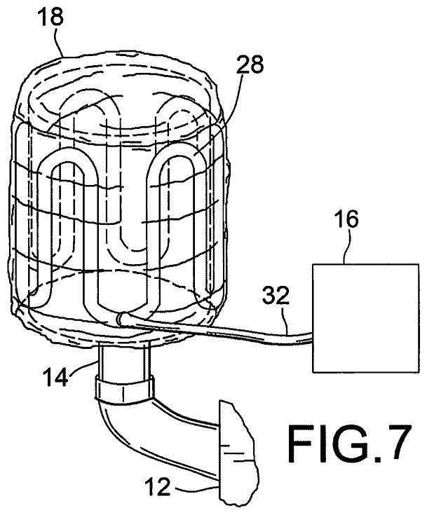

The heating element 28 comprises a plurality of coils 30 that is integrated into the outer wall 22 of the sock 18 having each of the coils 30 extending substantially between the top wall 20 and the distal edge 24 of the outer wall 22. Additionally, the coils 30 are spaced apart from each other and are distributed around the outer wall 22. The heating element 28 may comprise an electronic heating element or the like with an operational temperature ranging between approximately 100.0 degrees fahrenheit and 120.0 degrees fahrenheit. A power cord 32 is coupled to the heating element 28 having the power cord 32 extending away from the sock 18. The power cord 32 attaches to the power source 16. As shown in FIG. 6, there may be a pair of clamps 34 each integrated into the power cord 32 and each of the clamps 34 is attachable to the power source 16 of the internal combustion engine 12 which may be a battery 36. Alternatively, as shown in FIG. 7, the power cord 32 may be attached directly to the power source which may be a generator or power inverter.

In use, the sock 18 is expanded to extend around and over the fuel filter 14 for when the vehicle is being operated in a cold environment. When fit over the fuel filter 14 the sock 18 resiliently compresses to conform to the shape of the fuel filter 14 compressing the heating element 28 towards the fuel filter 14. The power source 16 of the internal combustion engine 12 is considered any conventional source of power associated with a tractor trailer or other typical vehicle or apparatus which utilizes an internal combustion engine. Each of the clamps on the power cord 32 is attached to the respective terminals 38 on the battery 36 to power the heating element 28. Alternatively, the power cord 32 can be attached to another separate battery, power takeoff, or power port. The heating element 28 may also be powered by attachment of the power cord 32 to an onboard generator or power inverter. In this way the heating element 28 warms the fuel filter 14 to inhibit the diesel fuel in the fuel filter 14 from gelling. Thus, the internal combustion engine 12 can be started without the difficulties that commonly arise from diesel fuel gelling in cold environments. Additionally, the heating element 28 ensures the fuel filter 14 continually delivers fuel at the manufacturer's intended rate and volume.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A resiliently expandable heated fuel filter cover system for warming a fuel filter of a diesel engine thereby inhibiting diesel fuel in the fuel filter from gelling in a cold environment, said system comprising:
an internal combustion engine having a fuel filter;
a sock being cylindrically structured thereby facilitating said sock to be slid over said fuel filter of said internal combustion engine, said sock being resiliently expandable and sized relative to said fuel filter such that said sock expands to fit over said fuel filter and compresses to squeeze against said fuel filter, said sock being flexible wherein said sock conforms to a shape of the fuel filter when said sock is fit over said fuel filter, said sock being comprised of a thermally insulating material to inhibit thermal communication between said fuel filter and ambient air; and
a heating element being integrated into said sock, said heating element being in thermal communication with said sock thereby facilitating said heating element to heat said sock when said heating element is turned on thereby facilitating said heating element to heat said fuel filter thereby inhibiting diesel fuel in said fuel filter from gelling in a cold environment.

2. The resiliently expandable heated fuel filter cover system according to claim 1, wherein:
said sock has a top wall and an outer wall extending downwardly from said top wall, said outer wall having a distal edge with respect to said top wall defining an opening into said sock, said outer wall being continuously arcuate around said top wall such that said sock defines a cylinder when not fit to said fuel filter; and
said heating element comprises a plurality of coils each being integrated into said outer wall of said sock having each of said coils extending substantially between said top wall and said distal edge of said outer wall, said coils being spaced apart from each other and being distributed around said outer wall.

3. The resiliently expandable heated fuel filter cover system according to claim 1, further comprising a power cord being coupled to said heating element and having an end portion extending away from said sock.

4. The resiliently expandable heated fuel filter cover system according to claim 3, wherein said power cord has a pair of clamps each integrated into said power cord, each of said clamps being attachable to a power source comprising a battery of said internal combustion engine.

5. The resiliently expandable heated fuel filter cover system according to claim 1, wherein said sock is free of rigid structural elements and said heating element is flexible wherein said heating element facilitates conforming of said sock to said shape of said fuel filter when said sock is fit over said fuel filter.

6. A resiliently expandable heated fuel filter cover system for warming a fuel filter of a diesel engine thereby inhibiting diesel fuel in the fuel filter from gelling in a cold environment, said system comprising:
an internal combustion engine having a fuel filter;
a sock being cylindrically structured thereby facilitating said sock to be slid over said fuel filter of said internal combustion engine, said sock being comprised of a thermally insulating material to inhibit thermal communication between said fuel filter and ambient air, said sock having a top wall and an outer wall extending downwardly from said top wall, said outer wall having a distal edge with respect to said top wall defining an opening into said sock, said outer wall being continuously arcuate around said top wall such that said sock defines a cylinder when not fit to said fuel filter, said sock being free of rigid structural elements and flexible wherein said sock conforms to a shape of the fuel filter when said sock is fit over said fuel filter;
a heating element being integrated into said sock, said heating element being flexible wherein said heating element facilitates conforming of said sock to said shape of said fuel filter when said sock is fit over said fuel filter, said heating element being in thermal communication with said sock thereby facilitating said heating element to heat said sock when said heating element is turned on thereby facilitating said heating element to heat said fuel filter thereby inhibiting diesel fuel in said fuel filter from gelling in a cold environment, said heating element comprising a plurality of coils each being integrated into said outer wall of said sock having each of said coils extending substantially between said top wall and said distal edge of said outer wall, said coils being spaced apart from each other and being distributed around said outer wall; and
a power cord being coupled to said heating element having said power cord extending away from said sock, said power cord having a pair of clamps each integrated into said power cord, each of said clamps being attachable to a power source of said internal combustion engine.
